(19) United States
(12) Patent Application Publication
(10) Pub. No.: US 2015/0058002 A1
(43) Pub. Date: Feb. 26, 2015

(54) Detecting Wind Noise In An Audio Signal

(71) Applicant: Telefonaktiebolaget L M Ericsson (publ), Stockhom (SE)

(72) Inventors: Zohra Yermeche, Solna (SE); Anders Eriksson, Uppsala (SE)

(73) Assignee: Telefonaktiebolaget L M Ericsson (publ), Stockhom (SE)

(21) Appl. No.: 13/508,990

(22) PCT Filed: May 3, 2012
(86) PCT No.: PCT/EP12/58114

§ 371 Date: Oct. 28, 2014

(51) Int. Cl. G10L 25/84

(52) U.S. Cl. CPC G10L 25/84
USPC 704/233

(57) ABSTRACT

A method of detecting wind noise in an audio signal includes calculating a power spectrum of the current frame, evaluating whether the current frame is non-stationary, evaluating whether an energy content of the current frame is concentrated at low frequencies and evaluating whether a periodicity is present in the power spectrum. The method further includes determining the presence of wind noise without speech in the current frame if the current frame is non-stationary, the energy content is concentrated at low frequencies, and a periodicity is not present. The periodicity of the power spectrum is analyzed using cepstrum coefficients. An improved wind noise detection may be achieved by analyzing the spectral characteristics of recorded audio signals.

### TECHNICAL FIELD

The invention relates to a method of detecting wind noise in an audio signal and a wind noise detector. The invention also relates to a computer program and a computer program product.

### BACKGROUND

Acoustic speech acquisition in outdoor environments is often subject to degradations due to simultaneous capturing of wind noise by microphones which a communication device, such as a mobile phone or a headset, is equipped with. This has a negative impact on the perceived quality of a voice call which a user of the communication device is engaged in.

Wind noise is an aerodynamic noise generated by turbulent airflow around obstacles. It is essentially a point-source noise in the near-field of the microphone and, hence, has different physical properties than background noise. Traditional noise suppression techniques are therefore inefficient in detecting and suppressing wind noise.

An audio signal representing wind noise can be characterized as being non-stationary and having low-frequency content and tonal frequency characteristics, which makes it difficult to distinguish wind noise from voiced speech, which has similar spectral characteristics.

Different approaches for the detection of wind noise in audio signals have been proposed. For instance, the solution disclosed in DE 100 45 197 C1 relies on the presence of two microphones for simultaneously capturing the sound field and on exploiting the power difference between the simultaneously recorded signals to conclude to the presence or absence of wind noise. The commercial application of the latter technique is hampered by the difficulty of distinguishing wind noise from voiced speech, due to their rather similar power spectra.

Other techniques rely on the comparison of the energy contained in particular frequency sub-bands to either predefined thresholds, or to the energy of corresponding frequency sub-bands in past signal frames (see, e.g., EP 1 519 626 A2). This approach suffers, however, from the difficulty to find appropriate thresholds that are generic enough for commercial applications.

### SUMMARY

It is an object of the invention to provide an improved alternative to the above techniques and prior art.

More specifically, it is an object of the invention to provide an improved detection of wind noise in audio signals.

These and other objects of the invention are achieved by means of different aspects of the invention, as defined by the independent claims. Embodiments of the invention are characterized by the dependent claims.

According to a first aspect of the invention, a method of detecting wind noise in an audio signal is provided. The method comprises, for a current frame of the audio signal, calculating a power spectrum of the current frame, evaluating whether the current frame is non-stationary, evaluating whether an energy content of the current frame is concentrated at low frequencies, evaluating whether a periodicity is present in the power spectrum of the current frame, and determining the presence of wind noise without speech in the current frame. The presence of wind noise without speech in the current frame is determined under the condition that the current frame is non-stationary, that the energy content of the current frame is concentrated at low frequencies, and that a periodicity is not present in the power spectrum of the current frame.

According to a second aspect of the invention, a computer program is provided. The computer program comprises computer program code. The computer program code is adapted, if executed on a processor, to implement the method according to the first aspect of the invention.

According to a third aspect of the invention, a computer program product is provided. The computer program product comprises a computer readable storage medium. The computer readable storage medium has the computer program according to the second aspect of the invention embodied therein.

According to a fourth aspect of the invention, a wind noise detector is provided. The wind noise detector comprises means for providing a current frame of an audio signal, means for calculating a power spectrum of the current frame, means for evaluating whether the current frame is non-stationary, means for evaluating whether an energy content of the current frame is concentrated at low frequencies, means for evaluating whether a periodicity is present in the power spectrum of the current frame, and means for determining the presence of wind noise without speech in the current frame. The means for determining the presence of wind noise without speech in the current frame is arranged for determining the presence of wind noise without speech in the current frame under the condition that the current frame is non-stationary, that the energy content of the current frame is concentrated at low frequencies, and that a periodicity is not present in the power spectrum of the current frame.

The invention makes use of an understanding that an improved detection of wind noise in sound fields captured by a communication device, such as a mobile phone, a headset, or any other built-in microphone, and which sound fields are represented by audio signals, may be achieved by analyzing the spectral characteristics of the audio signals on a more detailed level than what is known in the art. In this respect, wind noise is characterized as being non-stationary, with the signal energy being concentrated at low frequencies, and rolling off at approximately the inverse frequency with increasing frequency. Typically, a wind noise spectrum decreases as a function of frequency for frequencies above 100 Hz, with a slope of approximately −12 db/octave. Speech, on the other hand, is characterized by the presence of specific resonances, i.e., peaks, in the power spectrum.

To this end, the detection of wind noise in the absence of speech is based on a number of tests, each of which attempts to either detect the presence or absence of wind noise in a current frame of the audio signal, or the presence or absence of speech in the current frame. Then, a combination of the results obtained from the different tests is used to conclude the presence of wind noise and the absence of speech in the current frame, or not.

For the purpose of describing the invention, a captured sound field may be represented by a continuous audio signal x(t) which, for the purpose of processing and transmitting the audio signal, may be packetized into frames, each frame comprising N discrete samples x(n) of the audio signal, where n=0, 1, . . . N−1. Typically, the duration of a frame is 10 or 20 ms, and the number of discrete samples in each frame depends on a sampling rate used for transforming the continuous audio signal into a discrete representation. The steps performed for detecting wind noise in an audio signal in accordance with an embodiment of the invention are performed sequentially, i.e., one frame at a time.

An embodiment of the invention is advantageous in that the problems associated with prior art wind noise detection techniques are overcome, or at least mitigated.

According to an embodiment of the invention, the power spectrum of the current frame is calculated using a fast Fourier transform (FFT) of the current frame. Using an FFT is a quick and efficient way of obtaining an estimate of the stationary noise power spectrum.

According to another embodiment of the invention, the evaluating whether the current frame is non-stationary comprises evaluating a difference between the power spectrum of the current frame and an average power spectrum of the audio signal, and determining that the current frame is non-stationary if an absolute value of the difference exceeds a first threshold. The average power spectrum is calculated as an average of the respective power spectra of past frames of the audio signal. To this end, the time dependence of the audio signal is evaluated by comparing the power spectrum of each audio frame with an average power spectrum calculated from past frames. A non-stationary power spectrum, i.e., a power spectrum which deviates from an average power spectrum by at least a certain amount, is considered to be an indicator for the presence of wind noise in the audio signal, owing to the non-stationary character of wind noise. The number of past frames, i.e., the duration of the audio signal, over which the averaging is performed may be selected in accordance with the application at hand. It may be determined by trial-and-error.

According to a further embodiment of the invention, the evaluating whether the energy content of the current frame is concentrated at low frequencies comprises dividing the power spectrum of the current frame into a plurality of frequency sub-bands, calculating a signal energy for each frequency sub-band, determining which frequency sub-band of the plurality of frequency sub-bands has the largest signal energy, and determining that the energy content of the current frame is concentrated at low frequencies if an index of the frequency sub-band with the largest signal energy is below a second threshold. To this end, the spectral characteristics of the audio signal, in particular the current frame, are analyzed in order to evaluate whether the energy content of the current frame is concentrated at low frequencies. Since wind noise is characterized by having the highest peak in the power spectrum at very low frequencies, the index of the frequency sub-band with the largest energy content being below the second threshold is considered to be indicative of the absence of unvoiced speech in the audio signal. If, on the other hand, the energy content of the current frame is covering higher frequencies, i.e., the index of the frequency sub-band with the largest energy content being equal to or above the second threshold, there is a possibility of unvoiced speech, or another type of audio signal with higher frequency content than wind noise, to be present. As an alternative to dividing the power spectrum into frequency sub-bands and determining the frequency sub-band having the largest signal energy, one may locate a global maximum of the power spectrum and determine whether the maximum is located below a frequency threshold. The global maximum of the power spectrum may, e.g., be determined by means of statistical analysis, by a curve fitting procedure, or by smoothing the power spectrum and subsequently locating the maximum.

According to yet another embodiment of the invention, the evaluating whether a periodicity is present in the power spectrum of the current frame comprises calculating autocorrelation coefficients for the current frame, calculating predictor coefficients, calculating cepstrum coefficients, calculating cepstral differences, determining the largest cepstral difference, and determining that no periodicity is present in the power spectrum of the current frame if the largest cepstral difference is lower than a third threshold. The predictor coefficients, also referred to as autoregressive parameters or autoregressive coefficients, are calculated by solving a set of equations for the autocorrelation coefficients. The set of equations may, e.g., be solved using the Levinson-Durbin recursion. The cepstrum coefficients are calculated using the predictor coefficients. The calculated cepstrum coefficients are used as a measure to estimate the periodicity of the current frame in the frequency domain, i.e., the power spectrum, in order to distinguish voiced speech from wind noise. This is achieved by detecting the presence of a peak in the cepstrum and evaluating how predominant the peak is. If the detected peak is predominant, i.e., larger than a threshold, the presence of voiced speech is concluded. If, on the other hand, no predominant peak is detected, the absence of voiced speech is concluded. The detection of the peak in the cepstrum may be done using the calculated cepstral differences, i.e., differences between subsequent cepstral coefficients. If the value of the largest cepstral difference is less than a threshold, a pronounced peak is not present and no periodicity is present in the power spectrum.

According to yet a further embodiment of the invention, the method further comprises attenuating the wind noise in the current frame. The attenuation is performed in response to determining the presence of wind noise without speech in the current frame. The suppression of wind noise may, e.g., be performed using noise suppression approaches based on spectral suppression or Wiener filtering.

According to another embodiment of the invention, an audio signal processing device is provided. The audio signal processing device comprises the wind noise detector.

According to yet another embodiment of the invention, a communication device is provided. The communication device comprises the wind noise detector. The communication device may, e.g., be a mobile phone, a headset, a tablet computer, or the like. A communication device, e.g., a mobile phone, in accordance with an embodiment of the invention is advantageous in that an improved wind noise detection, and wind noise suppression/attenuation, may result in an enhanced user experience during voice calls.

Further objectives of, features of, and advantages with, the invention will become apparent when studying the following detailed disclosure, the drawings, and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 exemplifies power spectra and corresponding cepstra of speech and wind noise, respectively.

FIG. 2 shows a method of detecting wind noise in an audio signal, in accordance with embodiments of the invention.

FIG. 3 shows a wind noise detector and a communication device, in accordance with embodiments of the invention.

All the figures are schematic, not necessarily to scale, and generally only show parts which are necessary in order to elucidate the invention, wherein other parts may be omitted or merely suggested.

### DETAILED DESCRIPTION

The recording of audio signals and the subsequent derivation of power spectra is known to persons skilled in the art and is to some extent described further below, in connection with embodiments of the invention. For the purpose of elucidating the invention, it suffices to mention that a sound field is typically captured and converted into an electric signal by means of a microphone. Subsequently, in order to subject the audio signal to audio processing and transport through a network, the audio signal may be digitalized, i.e., represented by a set of discrete values, and packetized into frames. The duration of one audio frame is typically fixed, e.g., by an audio coding standard, and is of the order of 10 or 20 ms. Audio processing is typically performed sequentially, i.e., one frame at a time, using a general purpose processor, a digital signal processor (DSP), or the like.

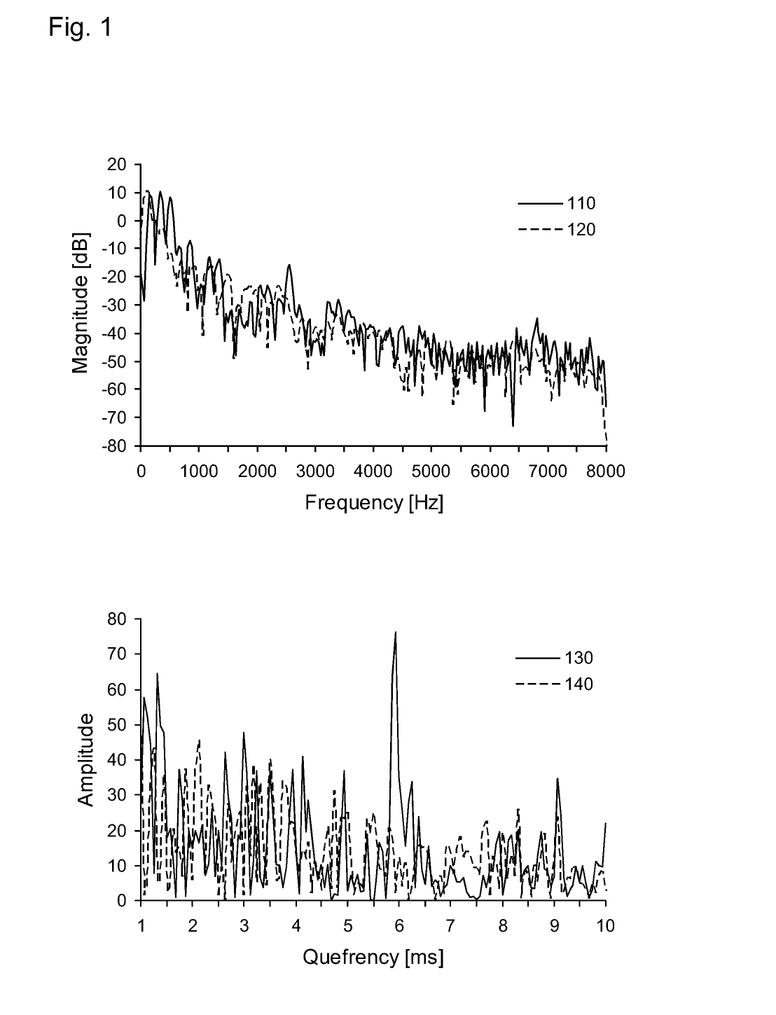

In the following, the invention will be described with reference to FIG. 1, which exemplifies power spectra and corresponding cepstra of speech and wind noise, respectively.

In FIG. 1, a typical power spectrum 110 of speech is shown, in comparison to a typical power spectrum 120 of wind noise without speech. The illustrated power spectra 110 and 120 illustrate the measured power as a function of frequency in the range between 0 and 8000 Hz. As can be seen from FIG. 1, it is difficult to reliably distinguish speech from wind noise by merely inspecting power spectra, owing to their rather similar spectral characteristics.

In order to more reliably distinguish wind noise from speech it is proposed to analyze recorded audio signals, in particular audio frames and their corresponding power spectra, on a more detailed level than what is known in the art. As part of this analysis, and in accordance with embodiments of the invention, the cepstrum is used as a measure to estimate the periodicity of the audio signal in the frequency domain and to distinguish speech spectra from wind noise spectra.

The cepstrum is defined as the inverse Fourier transform of the logarithm of the magnitude of the Fourier transform X(e^{iω}) of an audio signal, i.e., an audio frame x(n):

$$c ( n ) = {\int }_{- π}^{+ π} log \vert X ( {e}^{iω} ) \vert {e}^{iω n} \frac{d ω}{2 π} for n = 0 , 1 , … , N - 1. \qquad ( 1 )$$

In order to elucidate the invention, cepstra 130 and 140, corresponding to power spectra 110 and 120, respectively, are shown in FIG. 1. Cepstra 130 and 140 are calculated using Eq. (1), where the number of samples, N, corresponds to the duration of an audio frame, in this case 10 ms. The independent variable of a cepstrum is called the frequency and is a measure of time, though not in the sense of a signal in the time domain. A peak in the cepstrum occurs because the underlying spectrum is periodic, and the position of the peak on the frequency axis is related to the period.

As is apparent from FIG. 1, cepstrum 130, which is calculated for an audio frame containing speech, is characterized by having peaks which are more pronounced as compared to cepstrum 140, which is calculated for an audio frame containing wind noise without speech.

This observation may be quantified by performing an analysis in accordance with embodiments of the invention, which are described in the following. To this end, for a given audio frame, an embodiment of the invention may be utilized to decide whether the audio frame which is being analyzed contains wind noise without speech, or if speech is present. In the first case, i.e., if the audio frame only contains wind noise and no speech, wind noise suppression and/or attenuation techniques may be applied to that frame.

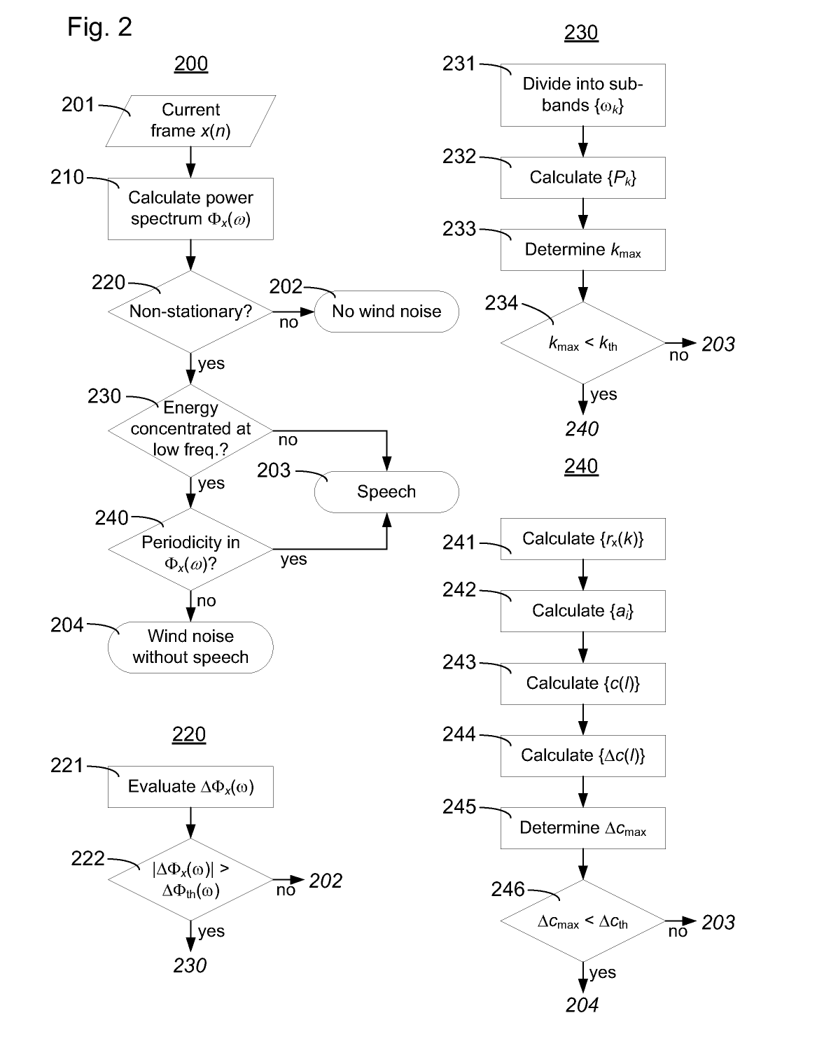

In the following, and with reference to FIG. 2, a method of detecting wind noise in an audio signal will be described, in accordance with embodiments of the invention.

Method 200 starts with providing 201 a current frame of a recorded audio signal, the current frame comprising N discrete samples x(n) of the audio signal, where n=0, 2, . . . N−1. In the next step 210, a power spectrum Φₓ(ω) of the current frame is calculated based on calculating the FFT of the current frame. Subsequently, it is evaluated 220 whether the current frame is non-stationary. For this purpose, the power spectrum Φₓ(ω) calculated for the current audio frame is compared to an average power spectrum Φ̅ₓ̅(ω).

More specifically, the average power spectrum Φ̅ₓ̅(ω) may be calculated by averaging a number of power spectra calculated for past audio frames. The number of past audio frames over which the average is calculated may, e.g., be chosen by trial-and-error. For the purpose of comparing the current power spectrum to the average power spectrum, a difference ΔΦₓ(ω) between the current power spectrum and the average power spectrum is calculated 221, i.e., ΔΦₓ(ω)=Φₓ(ω)− Φ̅ₓ̅(ω). Subsequently, an absolute value |ΔΦₓ(ω)| of the difference is compared 222 to a threshold value ΔΦₜₕ, or a threshold spectrum ΔΦₜₕ(ω). If the absolute value of the calculated difference, |ΔΦₓ(ω)|, exceeds the threshold ΔΦₜₕ or ΔΦₜₕ(ω), it is concluded that the current frame is non-stationary, which is considered to be indicative of the presence of wind noise in the current frame, and method 200 continues with step 230. Otherwise, if |ΔΦₓ(ω)| does not exceed ΔΦₜₕ or ΔΦₜₕ(ω), it is concluded 202 that wind noise is not present in the current audio frame.

If it has been concluded, in step 220, that the current audio frame is non-stationary, method 200 continues in step 230 with evaluating whether an energy content of the current frame is concentrated at low frequencies. For this purpose, the maximum of the current power spectrum Φₓ(ω), in particular the location of the maximum on the frequency axis, is determined.

More specifically, the current power spectrum Φₓ(ω) is divided 231 into M frequency sub-bands, where k=1 . . . M. Preferably, the frequency sub-bands are evenly distributed with respective center frequencies ωₖ. Then, a signal energy Pₖ is calculated 232 for each frequency sub-band. The signal energy Pₖ is the energy contained within frequency sub-band k. In step 233, the frequency sub-band with the maximum signal energy is determined. This may, e.g., be achieved by determining the index kₘₐₓ of the sub-band having the maximum signal energy. Subsequently, index kₘₐₓ is compared 234 to a threshold kₜₕ. If kₘₐₓ is less than threshold kₜₕ, it is concluded that the current power spectrum has a maximum at low frequencies, which is indicative of the presence of wind noise, and method 200 continues with step 240. Otherwise, if kₘₐₓ exceeds threshold kₜₕ, it is concluded 203 that the current frame contains speech.

It will be appreciated by those skilled in the art that there are alternative ways of determining whether a power spectrum has a maximum at low frequencies. For instance, instead of determining an index of the frequency sub-band having the maximum signal energy, a center frequency, or an upper or lower bound of the frequency range covered by the sub-band, may be determined and compared to a threshold value. As a further alternative, one may envisage embodiments of the invention which utilize smoothing of the power spectrum and a subsequent determination of the global maximum, in particular its location, of the spectrum.

Further with reference to FIG. 2, under the condition that it has been concluded that the energy content of the current frame is concentrated at low frequencies, method 200 continues with step 240 by evaluating whether a periodicity is present in the current power spectrum. In order to estimate a periodicity of the current power spectrum Φₓ(ω), the cepstral coefficients of the power spectrum are calculated, as is outlined in the following.

The cepstral coefficients of the power spectrum of the current audio frame may be determined by utilizing an autoregressive model of the audio frame x(n), i.e., by representing each sample x(n) of the current audio frame as linear combination of p previous samples of the current frame,

x(n)=Σᵢ₌₁^{p}aᵢx(n−i)+const(n) for n=0,1, . . . ,N−1 (2),

In Eq. (2), the aᵢ are the autoregressive coefficients or predictor coefficients and const(n) is the so-called excitation which may generally be ignored. Once the autoregressive coefficients are obtained, the cepstral coefficients may be calculated, as is described further below.

In accordance with an embodiment of the invention, the predictor coefficients aᵢ are obtained by first calculating the autocorrelation coefficients rₓ(k) of the current frame 241,

rₓ(k)=Σₙ₌₁^{N-1-k}x(n)x(n+k) for k=1,2, . . . ,P (3).

Subsequently, the predictor coefficients aᵢ may be calculated 242 by solving

Σᵢ₌₁^{p}aᵢrₓ(k−i)=rₓ(k) for k=1,2, . . . ,P (4).

The system of equations defined by Eq. (4) may, e.g., be solved by using a matrix formulation of Eq. (4) using the Levinson-Durbin recursion algorithm. Given the Toeplitz structure of the autocorrelation matrix, i.e., the left side of Eq. (4), the Levinson-Durbin recursion algorithm is a computationally efficient algorithm for this purpose.

Then, the cepstrum coefficients c(l) are calculated 243 as

c(l)=aₗ+1/lΣᵢ₌₁^{l-1}ic(i)aₗ₋ᵢ for l=1,2, . . . ,p (5),

and the cepstral differences Δc(l) are calculated 244 as differences between subsequent cepstral coefficients,

Δc(l)=c(l)−c(l−1) for l>1 (6).

Once the cepstral differences have been calculated 244, the largest cepstral difference Δcₐₓ is determined 245. Finally, the largest cepstral difference Δcₘₐₓ is compared 246 to a threshold Δcₜₕ. Under the condition that Δcₘₐₓ is lower than Δcₜₕ, it is concluded 204 that no periodicity is present in the current power spectrum, which is an indication for the presence of wind noise without speech in the current audio frame. Otherwise, if Δcₘₐₓ is not lower than Δcₜₕ, it is determined that a periodicity is present in the current power spectrum, which is an indication of the presence of speech in the current audio frame 203.

Thus, if method 200 terminates at 204, it is concluded that the current audio frame contains wind noise without speech. In order to arrive at this conclusion, it has been determined that the current frame is non-stationary 220, that the energy content of the current frame is concentrated at low frequencies 230, and that a periodicity is not present in the power spectrum of the current frame 240.

It will be appreciated that not all steps of method 200 described hereinbefore need to be performed for each audio frame which is being processed in accordance with an embodiment of the invention. For instance, if it is concluded, in step 220, that the current power spectrum is not non-stationary, i.e., the corresponding audio frame does not contain wind noise, method 200 may terminate for the audio frame being processed and the subsequent steps, such as finding the maximum in the power spectrum and calculating the cepstrum differences, need not be performed. In this way, if method 200 is performed by a digital audio processor, the amount of processing to be performed may be reduced. Correspondingly, if it is concluded, in step 230, that the signal energy of the current frame is not concentrated at low frequencies, i.e., the audio frame does contain speech, the subsequent steps, such as calculating the cepstrum differences, need not be performed.

In the following, the method described hereinabove is exemplified. For this purpose, cepstral differences Δc(l) have been calculated for power spectra 110 and 120 shown in FIG. 1 using Eqs. (3) to (6). The result is summarized in the following table.

| / = | 1 | 2 | 3 | 4 | 5 | 6 | 7 | 8 |
|---|---|---|---|---|---|---|---|---|
| speech | 0 | 0 | 0 | 0 | 0 | 0 | 83.6 | 38.2 |
| wind noise | 0 | 0 | 0 | 0 | 27.6 | 0 | 14.5 | 0 |

As can been seen from the table, the speech power spectrum 110 is characterized by a larger maximum cepstral difference than the wind noise power spectrum 120, Δc(7)=83.6 for speech as compared to Δc(5)=27.6 for wind noise.

As a consequence, by selecting the threshold Δcₜₕ appropriately, the calculated cepstral differences of a power spectrum, which power spectrum is calculated for a given audio frame, may be used for deciding whether the audio frame contains wind noise without speech or whether it contains speech, in accordance with an embodiment of the invention. To this end, if the largest cepstral difference is larger than the threshold, it is concluded that the audio frame contains speech, and wind noise suppression or attenuation techniques are not applied. Otherwise, if the largest cepstral difference is less than the threshold, it is concluded that the audio frame contains wind noise without speech, and wind noise suppression or attenuation techniques may be applied.

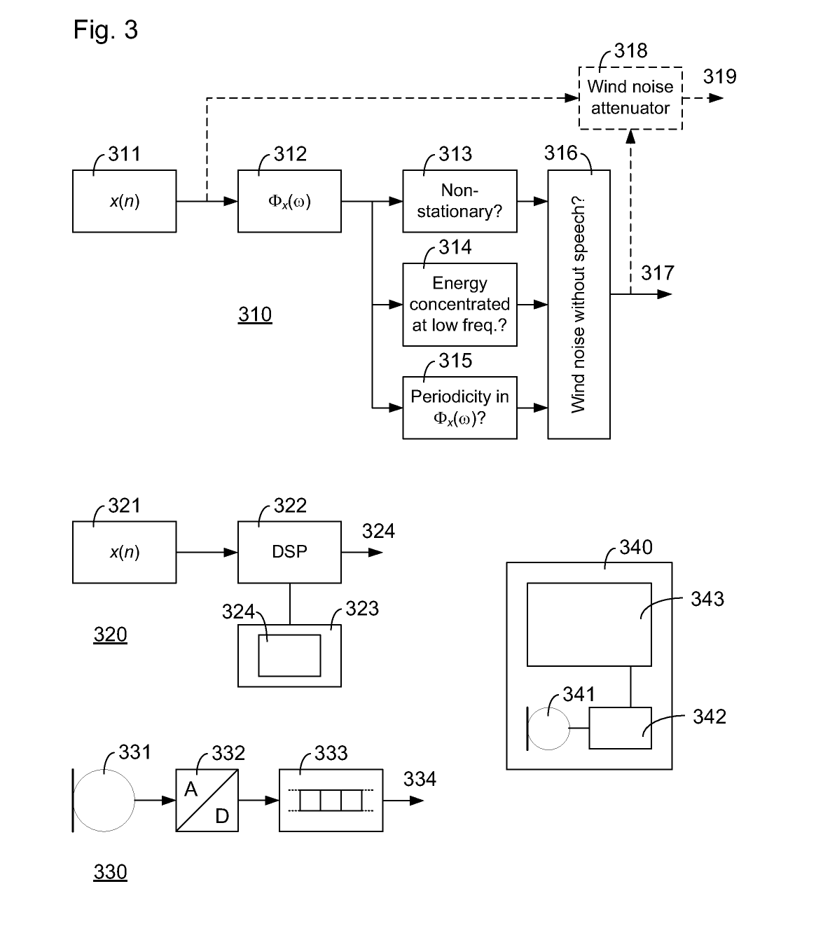

In the following, and with reference to FIG. 3, a wind noise detector will be described, in accordance with embodiments of the invention. Reference is also made to the description of embodiments of the method according to the first aspect of the invention.

Wind noise detector 310 comprises means 311 for providing a current frame of an audio signal. The current frame comprises N discrete samples x (n) of the audio signal, where n=0, 1, . . . N−1. Wind noise detector 310 further comprises means 312 for calculating a power spectrum Φₓ(ω) of the current frame, means 313 for evaluating whether the current frame is non-stationary, means 314 for evaluating whether an energy content of the current frame is concentrated at low frequencies, means 315 for evaluating whether a periodicity is present in the power spectrum of the current frame, and means 316 for determining the presence of wind noise without speech in the current frame. Means 316 is arranged for determining the presence of wind noise without speech in the current frame under the condition that the current frame is non-stationary, that the energy content of the current frame is concentrated at low frequencies, and that a periodicity is not present in the power spectrum of the current frame. Means 316 may further be arranged for providing a signal 317 indicating the presence or absence of wind noise without speech in the current frame.

Means 312 for calculating a power spectrum of the current frame is arranged for calculating the power spectrum based on an FFT of the current frame. Using FFTs is a quick and efficient way of performing Fourier transforms. However, the invention is not limited to FFTs and alternative methods for calculating Fourier transforms may be utilized.

Means 313 for evaluating whether the current frame is non-stationary is arranged for evaluating a difference ΔΦₓ(ω) between the power spectrum Φₓ(ω) of the current frame and an average power spectrum Φ̅ₓ̅(ω) of the audio signal and determining that the current frame of the audio signal is non-stationary. The average power spectrum is calculated as an average of the respective power spectra of past frames of the audio signal. Means 313 is arranged for determining that the current frame of the audio signal is non-stationary if an absolute value |ΔΦₓ(ω)| of the difference exceeds a first threshold ΔΦₜₕ.

Means 314 for evaluating whether the energy content of the current frame is concentrated at low frequencies is arranged for dividing the power spectrum Φₓ(ω) of the current frame into a plurality of frequency sub-bands ωₖ, k=1 . . . M, calculating a signal energy Pₖ for each frequency sub-band, determining which frequency sub-band of the plurality of frequency sub-bands has the largest signal energy, and determining that the energy content of the current frame is concentrated at low frequencies. Means 314 is arranged for determining that the energy content of the current frame is concentrated at low frequencies if an index kₘₐₓ of the frequency sub-band with the largest signal energy is below a second threshold kₜₕ.

Means 315 for evaluating whether a periodicity is present in the power spectrum of the current frame is arranged for calculating autocorrelation coefficients rₓ(k) of the current frame (Eq. (3)), calculating predictor coefficients aᵢ by solving the set of equations defined by Eq. (4), calculating cepstrum coefficients c(l) using Eq. (5), calculating cepstral differences Δc(l) using Eq. (6), determining the largest cepstral difference Δcₘₐₓ, and determining that no periodicity is present in the power spectrum of the current frame. Means 315 is arranged for determining that no periodicity is present in the power spectrum of the current frame if the largest cepstral difference is lower than a threshold Δcₜₕ.

Optionally, wind noise detector 310 may comprise a wind noise attenuator 318 for suppressing and/or attenuating wind noise in the current audio frame in response to receiving an indication, e.g., by means of signal 317, that the current audio frame contains wind noise without speech. The resulting audio signal 319, with suppressed/attenuated wind noise, may be provided to other units for further signal processing or transmission.

As illustrated in FIG. 3, wind noise detector 310, and in particular means 311-316 as well as attenuator 318, may be implemented by separate functional units based on hardware, i.e., electronic circuitry, or software. These functional units may perform their respective tasks independently of each other and interact by means of signaling. For instance, means 316 for determining the presence of wind noise without speech in the current frame may receive indications, i.e., signals, from means 313-315, in response to which means 316 determines the presence or absence of wind noise without speech in the current frame.

As an alternative, an embodiment of the invention may be implemented as a computer program, i.e., software, to be executed on a processor, either a general purpose processor or a DSP. For instance, as is illustrated in FIG. 3, an embodiment 320 of the invention may comprise means 321 for providing a current frame of an audio signal, such as means 311 of wind noise detector 310, processing means 322, and computer storage medium 323, e.g., a memory. Processing means 322 may be a general purpose processor or a DSP. Computer program 324 is stored in memory 323 and may be loaded into processor 322 for execution. Computer program 324 comprises computer program code which is adapted, if executed on processor 322, to implement an embodiment of the method according to the first aspect of the invention. In this way, an existing digital signal processing resources, such as existing audio processing equipment, computer soundcards, mobile phones or other communication devices, and so forth, may be adapted to perform in accordance with an embodiment of the invention. This may, e.g., be achieved by upgrading the software, or firmware, of a mobile phone with a computer program in accordance with an embodiment of the invention.

An embodiment of the computer program in accordance with the second aspect of the invention may be provided as a computer program product comprising a computer readable storage medium. The computer readable storage medium has the computer program according to second aspect of the invention embodied therein. The computer readable storage medium may, e.g., be memory 323, a memory stick, or any other type of data carrier. It will also be appreciated that an embodiment of the computer program may be provided by means of downloading the computer program over a communication network, e.g., a mobile network to which a user of a mobile phone is subscribed to.

Further with reference to FIG. 3, an embodiment of means 311 and 321 for providing a current frame of an audio signal is exemplified. Means 330 for providing a current frame of an audio signal comprises a microphone 331 for capturing a sound field and converting it into an electric signal. In order to subject the recorded audio signal to audio processing and transport through a communication network, the recorded audio signal may be digitalized, i.e., represented by a set of discrete values, using an analog-to-digital converter (ADC). Means 330 further comprises means 333 for dividing the recorded and discretized audio signal into frames. The duration of one audio frame is typically fixed, e.g., by an audio coding standard, and is of the order of 10 or 20 ms. Means 332 and 333 are functional units which may be implemented in hardware, software, or a combination thereof.

In general, an embodiment of the invention may be implemented by hardware, software, or any combination thereof. Parts of embodiments which have been described as separate means or functional units may be implemented separately or in combination.

An audio signal processing device in accordance with an embodiment of the invention may be implemented in any device capable of recording sound, such as a computer audio card, a mobile phone or other communication device, a headset, an audio recording device, and the like. For instance, a mobile phone 340 is illustrated in FIG. 3 as an example for a communication device in accordance with an embodiment of the invention. Mobile phone 340 comprises a microphone 341 and a wind noise detector 342. Wind noise detector 342 may, e.g., be an embodiment of wind noise detector 310. As an alternative, wind noise detector 342 may be an embodiment of wind noise detector 320, i.e., comprising a processor for executing a computer program implementing an embodiment of method 200. It will be appreciated that mobile phone 340 may comprise further parts 343, such as a radio communication unit and an antenna, a screen, a loudspeaker, and so forth.

The person skilled in the art realizes that the invention by no means is limited to the embodiments described above. On the contrary, many modifications and variations are possible within the scope of the appended claims.

1. A method of detecting wind noise in an audio signal, the method comprising, for a current frame comprising N discrete samples x(n) of the audio signal, where n=0, 1, . . . N−1:
calculating a power spectrum Φₓ(ω) of the current frame,
evaluating whether the current frame is non-stationary,
evaluating whether an energy content of the current frame is concentrated at low frequencies,
evaluating whether a periodicity is present in the power spectrum of the current frame, and
determining, under the condition that the current frame is non-stationary, that the energy content of the current frame is concentrated at low frequencies, and that a periodicity is not present in the power spectrum of the current frame, the presence of wind noise without speech in the current frame.

2. The method according to claim 1, wherein the power spectrum of the current frame is calculated using a fast Fourier transform of the current frame.

3. The method according to claim 1, wherein the evaluating whether the current frame is non-stationary comprises:
evaluating a difference ΔΦₓ(ω) between the power spectrum Φₓ(ω) of the current frame and an average power spectrum Φ̅ₓ̅(ω) of the audio signal, which average power spectrum is calculated as an average of the respective power spectra of past frames of the audio signal, and
determining, under the condition that an absolute value |ΔΦₓ(ω)| of the difference exceeds a first threshold ΔΦₜₕ, that the current frame is non-stationary.

4. The method according to claim 1, wherein the evaluating whether the energy content of the current frame is concentrated at low frequencies comprises:
dividing the power spectrum Φₓ(ω) of the current frame into a plurality of frequency sub-bands ωₖ, k=1 . . . M,
calculating a signal energy Pₖ for each frequency sub-band,
determining which frequency sub-band of the plurality of frequency sub-bands has the largest signal energy, and
determining, under the condition that an index kₘₐₓ of the frequency sub-band with the largest signal energy is below a second threshold kₜₕ, that the energy content of the current frame is concentrated at low frequencies.

5. The method according to claim 1, wherein the evaluating whether a periodicity is present in the power spectrum of the current frame comprises:
calculating autocorrelation coefficients rₓ(k) for the current frame,
$${r}_{x} ( k ) = {\sum }_{n = 1}^{N - 1 - k} x ( n ) x ( n + k ) for k = 1 , 2 , … , p ,$$
calculating predictor coefficients aᵢ by solving
$${\sum }_{i = 1}^{p} {a}_{i} {r}_{x} ( k - i ) = {r}_{x} ( k ) for k = 1 , 2 , … , p ,$$
calculating cepstrum coefficients
$$c ( l ) = {a}_{l} + \frac{1}{l} {\sum }_{i = 1}^{l - 1} ic ( i ) {a}_{l - i} for l = 1 , 2 , … , p ,$$
calculating cepstral differences
Δc(l)=c(l)−c(l−1) for l>1,
determining the largest cepstral difference Δcₘₐₓ, and
determining, under the condition that the largest cepstral difference is lower than a third threshold Δcₜₕ, that no periodicity is present in the power spectrum of the current frame.

6. The method according to claim 1, further comprising:
attenuating, in response to determining the presence of wind noise without speech in the current frame, the wind noise in the current frame.

7. A computer program comprising computer program code, the computer program code being adapted, if executed on a processor, to implement the method according to claim 1.

8. A computer program product comprising a computer readable storage medium, the computer readable storage medium having the computer program according to claim 7 embodied therein.

9. A wind noise detector comprising:
means for providing a current frame of an audio signal, the current frame comprising N discrete samples x(n) of the audio signal, where n=0, 1, . . . N−1,
means for calculating a power spectrum Φₓ(ω) of the current frame,
means for evaluating whether the current frame is non-stationary,
means for evaluating whether an energy content of the current frame is concentrated at low frequencies,
means for evaluating whether a periodicity is present in the power spectrum of the current frame, and
means for determining, under the condition that the current frame is non-stationary, that the energy content of the current frame is concentrated at low frequencies, and that a periodicity is not present in the power spectrum of the current frame, the presence of wind noise without speech in the current frame.

10. The wind noise detector according to claim 9, wherein the means for calculating a power spectrum of the current frame is arranged for calculating the power spectrum based on a fast Fourier transform of the current frame.

11. The wind noise detector according to claim 9, wherein the means for evaluating whether the current frame is non-stationary is arranged for:
evaluating a difference ΔΦₓ(ω) between the power spectrum Φₓ(ω) of the current frame and an average power spectrum Φ̅ₓ̅(ω) of the audio signal, which average power spectrum is calculated as an average of the respective power spectra of past frames of the audio signal, and
determining, under the condition that an absolute value |ΔΦₓ(ω)| of the difference exceeds a first threshold ΔΦₜₕ, that the current frame of the audio signal is non-stationary.

12. The wind noise detector according to claim 9, wherein the means for evaluating whether the energy content of the current frame is concentrated at low frequencies is arranged for:
dividing the power spectrum Φₓ(ω) of the current frame into a plurality of frequency sub-bands ωₖ, k=1 . . . M,
calculating a signal energy Pₖ for each frequency sub-band,
determining which frequency sub-band of the plurality of frequency sub-bands has the largest signal energy, and
determining, under the condition that an index kₘₐₓ of the frequency sub-band with the largest signal energy is below a second threshold kₜₕ, that the energy content of the current frame is concentrated at low frequencies.

13. The wind noise detector according to claim 9, wherein the means for evaluating whether a periodicity is present in the power spectrum of the current frame is arranged for:
calculating autocorrelation coefficients rₓ(k) for the current frame,
$${r}_{x} ( k ) = {\sum }_{n = 1}^{N - 1 - k} x ( n ) x ( n + k ) for k = 1 , 2 , … , p ,$$
calculating predictor coefficients aᵢ by solving
$${\sum }_{i = 1}^{p} {a}_{i} {r}_{x} ( k - i ) = {r}_{x} ( k ) for k = 1 , 2 , … , p ,$$
calculating cepstrum coefficients
$$c ( l ) = {a}_{l} + \frac{1}{l} {\sum }_{i = 1}^{l - 1} ic ( i ) {a}_{l - i} for l = 1 , 2 , … , p ,$$
calculating cepstral differences
Δc(l)=c(l)−c(l−1) for l>1,
determining the largest cepstral difference Δcₘₐₓ, and
determining, under the condition that the largest cepstral difference is lower than a third threshold Δcₜₕ, that no periodicity is present in the power spectrum of the current frame.

14. The wind noise detector according to claim 9, further comprising:
means for attenuating, in response to determining the presence of wind noise without speech in the current frame, the wind noise in the current frame.

15. An audio signal processing device comprising the wind noise detector according to claim 9.

16. A communication device comprising the wind noise detector according to claim 9.
